(19) United States
(12) Patent Application Publication
(10) Pub. No.: US 2008/0231990 A1
(43) Pub. Date: Sep. 25, 2008

(54) CLAMPS FOR SECURING A MEDIUM IN A MEMORY STORAGE DEVICE

(75) Inventor: Motoyuki Dohya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/043,520

(22) Filed: Mar. 6, 2008

(30) Foreign Application Priority Data
Mar. 23, 2007 (JP) 2007-076134

(51) Int. Cl. G11B 17/02

(52) U.S. Cl. 360/99.12

(57) ABSTRACT

A storage medium device in which one or more storage media used for storing data can be mounted includes a drive unit for rotating the storage medium, and a hub that permits stacking of multiple storage media, the hub being coupled to the drive unit. A clamp is secured by a load applied to the storage media which passes through the hub. The clamp includes an upper surface having a mechanism for fixture to the hub, a weld part for welding to the storage media and applying a load to the storage media, and a sidewall forming a cylinder around the hub. The sidewall having openings, and joining the upper surface and the weld part. The clamp is particularly useful when less than all of the media the storage device is designed to accommodate are provided in the storage device.

The present invention relates to clamps for securing one or more rotating storage media in storage medium devices, storage devices using the clamp, and methods for making the clamp. More particularly, the present invention relates to clamps for a storage medium device having only one storage medium in a storage device that can stack multiple storage media.

### BACKGROUND

Generally, as shown in FIG. 5A, multiple storage media 500 are stacked in a data storage device wherein several storage media are separated by one or more spacers 503 on the hub 502 for the spindle motor 501, by which the storage media 500 are rotated. The storage medium device is constructed so the load of the clamp 504 is applied to the stacked storage media from above, thereby fixing the media into place.

A HDD(hard disk drive) is a typical example of such a storage medium device. In addition to having improved performance, HDD is seeing use in diverse applications across many fields in recent years. Consequently, even when HDD is externally identical, HDD which has a variety of storage capacities are available.

Sometimes the necessary memory capacity can be realized by having only one storage medium in an externally identical HDD having minimal storage capacity. Thus, a configuration having only one storage medium 500, as shown in FIG. 5B is used. By using a spacer 505, which is shaped differently from conventional spacers used between the storage medium 500 and the clamp 504, unnecessary storage media can be removed, yet the shape of the HDD is the same as devices having multiple storage media.

Because this method required the use of a spacer like conventional methods, management costs for multiple types of spacers and man-hours for assembly were required, so costs could not be sufficiently reduced. In recent years, a bell-shaped clamp having a sidewall running along the hub sidewall has been used instead of the spacer 505.

However, changing the shape of the clamp into a bell-like shape only improved the clamp stiffness. As a result, the spring constant of the clamp increased. As the temperature changed in the environment within which the HDD was used, changes in the clamping strength increased as thermal expansion or contraction occurred in the clamp member. Changes occurred in the shape of the storage media as well. As a result, performance of the heads that read or write data on the storage media due to surface stability of the heads worsened. In the worst cases, there is concern that the heads and storage media will both crash. There is also concern that the storage media will become displaced due to the increased risk of loosening in the fastening members such as screws which fasten the storage media, making it impossible to read or write data.

Various solutions such as increasing the board thickness of the clamp member have been presented as methods for decreasing the clamp stiffness and reducing the spring constant. For example, the moment was reduced by decreasing the wall thickness of a part of the clamp (see Japanese Laid-open Patent Application Publication No. H5-89629). A method of providing slots at predetermined locations in the clamp was proposed to facilitate the elastic deformation of the clamps (see Japanese Laid-open Patent Application Publication No. 2005-216470).

However, simply decreasing the plate thickness of the bell-shaped clamp reduces the overall stiffness of the bell-shaped clamp. Consequently, there is a problem where even the stiffness of the weld to the storage medium by which a load is applied to the storage medium will be reduced.

As shown in Japanese Laid-open Patent Application Publication No. H5-89629, in order to realize a shape in which the wall thickness of a part of the clamp is decreased, the squeeze treatment method or the shave treatment method is typically used. If such a shape is realized through the squeeze treatment, extra thickness equal to the amount by which the wall thickness of the treated area was reduced is produced in the area proximal to the treated area.

However, locations around the hub of the bell-shaped clamp do not have sufficient room to accommodate such extra shapes. The shape of the member periphery must therefore be redesigned. On the other hand, if the shave treatment method is used, such shapes can be realized by shaving down the unnecessary areas. Compared to the squeeze treatment method, however, significant man-hours are required by this method, leading to significantly increased manufacturing cost.

If a slot shape like that described in Japanese Laid-open Patent Application Publication No. 2005-216470 is provided in the clamp, elastic deformation in the vicinity of the welds to the storage device is more likely to occur. Hence, when a load is to be applied to the storage medium, this shape is not preferable.

An object of the present invention is to provide a bell-shaped clamp wherein the stiffness is reduced only in areas where stiffness is unnecessary but maintained in areas where stiffness is necessary. A further object of the present invention is to provide the aforementioned clamp while suppressing increases in the manufacturing cost of the clamp.

A further object of the present invention is to improve the reliability of the data reading process and writing process in a HDD having only a single storage medium.

### SUMMARY

In accordance with an aspect of the present embodiment, a storage medium device in which one or more storage media used for storing data can be mounted includes a drive unit for rotating the storage medium, and a hub that permits stacking of multiple storage media, the hub being coupled to the drive unit. A clamp is secured by a load applied to the storage media which passes through the hub. The clamp includes an upper surface fixed to the hub, a weld part for welding to the storage media and applying a load to the storage media, and a sidewall forming a cylinder around the hub, and joining the upper surface and the weld part. The sidewall has openings.

### BRIEF DESCRIPTION OF THE DRAWINGS

FIG. 1 is a schematic view of a HDD;

FIG. 2 is a cross-sectional view of a magnetic disk in the present invention;

FIG. 3 is a perspective view of a bell-shaped clamp provided by the present invention;

FIG. 4A is a plan view and cross-sectional view of the process of manufacturing the bell-shaped clamp provided by the present invention prior to the squeeze treatment;

FIG. 4B is a plan view and cross-sectional view of the process of manufacturing the bell-shaped clamp provided by the present invention after the squeeze treatment;

FIG. 4C is a plan view and cross-sectional view of the process of manufacturing the bell-shaped clamp provided by the present invention after the bend treatment;

FIG. 5A is a cross-sectional view of a conventional example in which a HDD has multiple disks; and

FIG. 5B is a cross-sectional view of a conventional example in which a HDD has a special spacer.

### DESCRIPTION OF THE PREFERRED EMBODIMENT

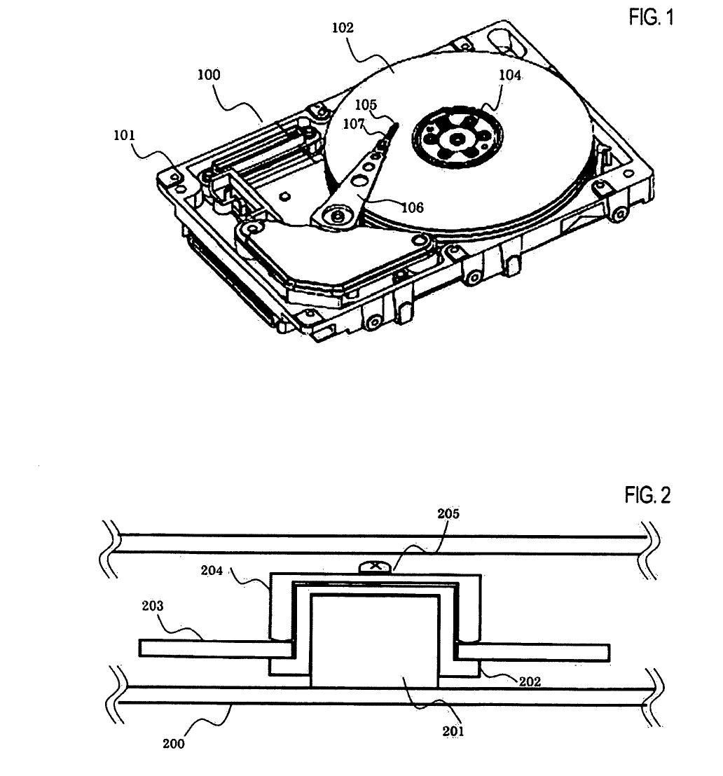

FIG. 1 is a schematic view of a HDD having multiple magnetic disks in a hub in which storage media represented by multiple magnetic disks can be stacked. A typical HDD will be explained using FIG. 1. As shown in FIG. 1, a HDD 100 has a chassis 101. The chassis 101 is composed of an aluminum die cast base, stainless steel, etc, has a rectangular shape, and is coupled to a cover (not shown) for sealing off the interior space.

A magnetic disk 102 stored inside the chassis 101 has a high surface recording density, e.g., 200 Gb/in² or greater. The magnetic disk 102 is fitted to the hub of a spindle motor 103 (not shown) via the hole provided in the center thereof. The magnetic disk 102 is secured by a clamp 104 by which a load is applied from the side opposite the spindle motor 103.

The chassis 101 also has a head slider 105 by which read processing or write processing is performed on the magnetic disk 102. A HSA (head stack assembly) 106 is provided, wherein the head slider is mounted at the tip thereof.

The head slider 105 comprises a slider body, and a built-in film head element composed of Al₂O₃ (alumina) which is joined to the air outflow edge of the slider and includes the read and write heads. The heads embedded into the head element are exposed at the ABS (air bearing surface). The heads in the present embodiment are a MR inductive composite head comprising an induction writing head element for writing binary information to the magnetic disk 102 using a magnetic field generated by an inductive coil pattern (not shown) (hereinafter referred to as “inductive head elements”), and a magnetic resistance effect (hereinafter referred to as “MR”) head element for reading binary information based on resistance which is changed according to the magnetic field exerted by the magnetic disk 102. The MR head element is used as an example here for the sake of explanation, but other types of head element, such as GMR (Giant Magneto Resistive) elements and TMR (Tunnel Magneto Resistive) elements using the tunnel magnetic resistance effect can be used.

The suspension 107, a Watrous suspension composed of stainless steel for example, has a function of applying elastic force against the magnetic disk 102 in relation to the head slider 105 while supporting the head slider 105. The suspension 107 comprises a flexure for providing cantilever support to the head slider 106 (also referred to as a gimbal spring or by another name), and a load beam which is connected to a base plate (also referred to as a load arm or by another name). A wiring unit (not shown) connected to the head slider 105 via lead lines, or the like, is also supported by the suspension 107. Sense current between the heads and the wiring unit, and information that was written or read is provided and output via such lead lines.

The HSA 106 is oscillated around the spindle by a voice coil motor (not shown). A FPC (flexible printed circuit) for providing control signals, signals to be recorded on the magnetic disk 102, and power to the wiring unit in addition to receiving signals reproduced from the magnetic disk 102 is also provided to the HSA 106.

FIG. 2, a cross-sectional view showing only one magnetic disk mounted onto a hub, will be used to explain a case in which only one magnetic disk is mounted onto the hub of a HDD which allows multiple stacked magnetic disks as shown in FIG. 1.

A hub 202 is attached to a spindle motor 201 fixed to a lower surface of the chassis 200. The magnetic disk 203 is fitted to the hub 202 by passing the hub 202 through the hole provided in the center of the magnetic disk. After the magnetic disk 203 has been fitted to the hub 202, a bell-shaped clamp 204 is secured onto the hub 202 using the screw hole 205 provided on the upper surface of the bell-shaped clamp 204. The magnetic disk 203 is then secured by the load applied thereto by the bell-shaped clamp 204.

Either a single or multiple screw holes 205 are provided in the upper surface of the bell-shaped clamp. The number of screw holes 205 is not limited to I like in the present embodiment. Screw holes can be placed according to the characteristics of the device, e.g., multiple holes can be placed concentrically at regular intervals.

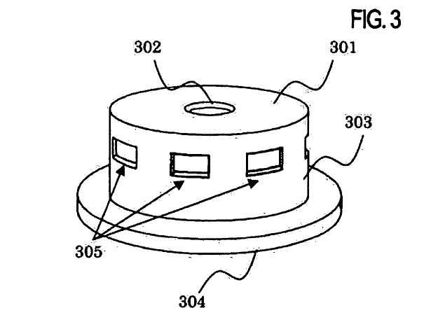

FIG. 3 is a perspective view of such a bell-shaped clamp in the present invention. A bell-shaped clamp 300 like that in the present invention is convex-shaped and has a sidewall by which a cylindrical shape is formed along the hub. The clamp has an upper surface 301, a screw hole 302 for fixing the bell-shaped clamp 300 provided on the upper surface to the hub 202 using a screw, the sidewall 303, and the weld part 304 which is welded to the magnetic disk and by which a load is provided to the magnetic disk.

The heightwise length of the sidewall 303, which is the length from the upper surface 301 to the weld part 304 shall be the length at which the weld part 304 can be welded in relation to the magnetic disk 203 when only one magnetic disk 203 is mounted on the hub 202. In other words, this length is determined according to the thickness of the number of magnetic disks remaining when one magnetic disk is subtracted from the maximum number of magnetic disks that can be stacked on the hub 202, and the thickness of the spacers required between the magnetic disks. Having a length such as this allows a load to be applied to the magnetic disks thereby securing them even if only one magnetic disk is mounted on a hub that can mount multiple magnetic disks.

An opening 305 is herein provided in the sidewall 303 in a single location or in multiple locations. Providing such openings makes it possible to reduce the stiffness of the bell-shaped clamp in the proximity of the openings 305. As a result, stiffness is reduced in areas where stiffness is unnecessary and the spring constant of the bell-shaped clamp can be reduced while maintaining stiffness in areas where stiffness is necessary.

The one or more openings 305 are preferably placed in locations where stiffness is unnecessary. Specifically, the upper side is preferable over the center in relation to the heightwise direction of the sidewall. Placing openings in the proximity of the boundary between the upper surface and the sidewall is most preferable. This is because if openings 305 were placed near the weld part 304, at the lower part of the sidewall 302, the spring constant in the locations where stiffness is necessary would decrease.

By using horizontally elongated openings 305 as shown in FIG. 3, reducing the stiffness only at the boundary between the upper face 301 where stiffness is unnecessary and the sidewall 302 is possible. By making the size of the openings between ½ and ¾ the circumference of the sidewall, the spring coefficient can be sufficiently reduced. In FIG. 3, the openings are shown as rectangular shaped, but the openings are not limited to such shapes and may be made into any shape, e.g. circular, or elliptical.

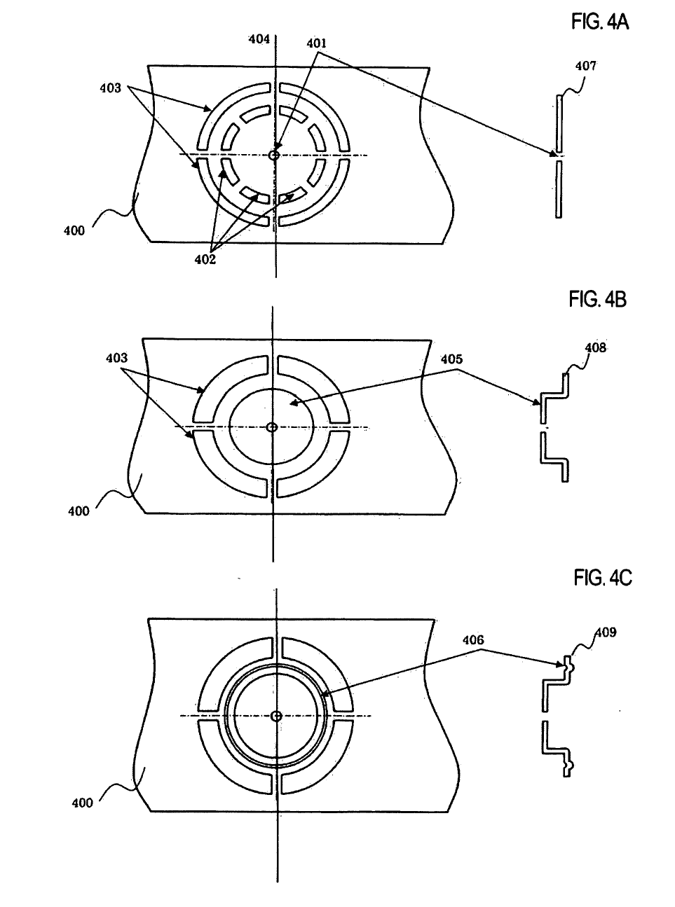

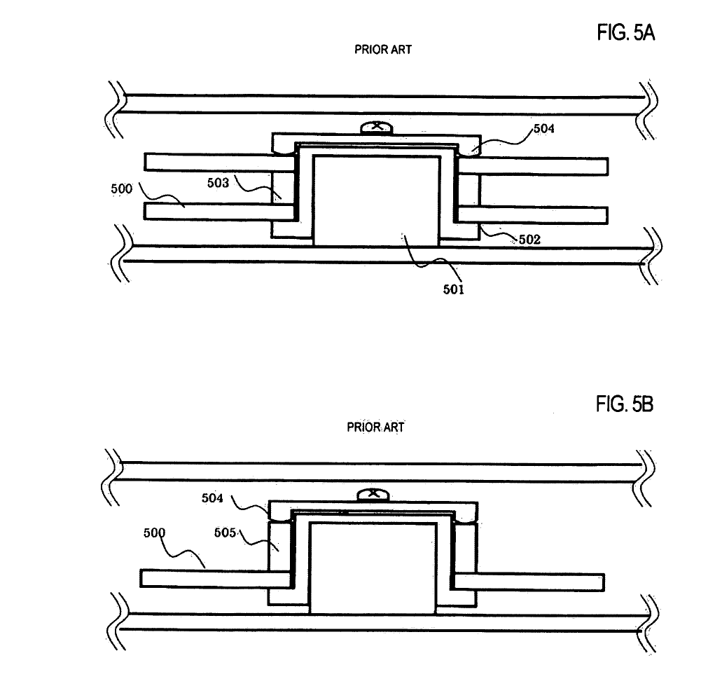

FIG. 4 will be used to explain a method of manufacturing of the present invention. FIG. 4A is a plan view of a flat plate material 400 composed of a metal, e.g. stainless steel or aluminum, which holes were punched through. FIG. 4A through FIG. 4C show cross-sectional views (407 through 409), along a line 404, of a flat plate material 400 for each treatment.

When holes are punched into the flat plate material 400, a first hole 401 to be used as the screw hole 302, second holes 402 to be used as the openings 305 provided in the sidewall 303, and third holes 403 for relieving the stress resulting during the squeeze treatment to be hereinafter explained are formed. More specifically, shapes corresponding to the planar shape of the bell-shaped clamp are formed on the flat plate material 400.

FIG. 4B shows the flat plate material 400 after holes are punched through, after pressurization treatment, and after squeeze treatment. More specifically, pressurization treatment is performed on the part 405 formed on the upper surface of the bell-shaped clamp centered on the first hole 401, and the deepest part of the bell-shaped clamp is squeezed. In this case, the second holes relieve stress by extending radially from the first hole 401 on which they are centered.

FIG. 4C shows the weld parts for welding to the magnetic disk after the bending treatment 406 is performed. By performing the bending treatment 406 on the weld parts to form portions protruding towards the storage device, the load applied to the magnetic disk by the bell-shaped clamp can be standardized.

A bell-shaped clamp such as one explained in the present invention is created by cutting the bell-shaped clamp from the flat plate material 400. Thus, by forming the openings 305 in the sidewall 303 during the hole punching process before performing the squeeze treatment process, a bell-shaped clamp can be easily realized without adding a special work process. Consequently, a bell-shaped clamp having a reduced spring constant can be easily provided without increasing manufacturing costs while maintaining the stiffness of the weld parts for welding to the magnetic disk.

What is claimed is:

1. A storage medium device in which one or more storage media used for storing data can be mounted, comprising:
a drive unit for rotating said storage medium;
a hub that permits stacking of multiple storage media, said hub being coupled to said drive unit; and
a clamp which is secured by a load applied to said storage media which passes through said hub, wherein said clamp includes:
an upper surface having a mechanism for fixture to said hub;
a weld part for welding to said storage media and applying a load to said storage media; and
a sidewall forming a cylinder around the hub, said sidewall having openings, and joining said upper surface and said weld part.

2. The storage medium device according to claim 1, wherein
the heightwise length of said cylinder is a length that allows welding of said weld part onto said one or more storage media when only one storage medium is mounted on said hub.

3. The storage medium device according to claim 1, wherein
said openings are provided in proximity to a connection part between said sidewall and said upper surface and so as to extend circumferentially in said cylinder.

4. A clamp by which one or more storage media are secured to a hub which permits stacking of multiple said storage media which are coupled to a drive unit for rotating said storage media, said clamp comprising:
an upper surface having a mechanism for fixture to said hub;
a weld part for welding to said storage media and applying a load to said storage media; and
a sidewall forming a cylinder around said hub, said sidewall having openings, and joining to said upper surface and said weld part.

5. The clamp according to claim 4, wherein
the heightwise length of said cylinder is a length allowing welding of said weld part onto said one or more storage media when only one storage medium is mounted on said hub.

6. The clamp according to claim 4, wherein
said openings are provided in proximity to a connection part between said sidewall and said upper surface, and so as to extend circumferentially in said cylinder.

7. A method of manufacturing a clamp by which storage media are secured in relation to a hub that permits stacking of multiple said storage media and is coupled to a drive unit for rotating said storage media, comprising the steps of:
forming holes in a metallic flat plate material, said holes comprising a first hole for securing said clamp onto said hub, second holes for reducing stiffness of said clamp, and third holes for relieving stress applied to said metallic material; and
squeeze treating said metallic material by applying pressure, thereby forming an upper surface having said first hole, a sidewall having said second holes, and a weld part for welding to said storage media.

8. The method of manufacturing a clamp according to claim 7, further comprising the step of bend treating said weld part.
